(19) United States
(12) Patent Application Publication
(10) Pub. No.: US 2009/0193486 A1
(43) Pub. Date: Jul. 30, 2009

(54) DIGITAL SET-TOP TERMINAL WITH PARTITIONED HARD DISK AND ASSOCIATED SYSTEM AND METHOD

(75) Inventors: Vipul Patel, Upper Holland, PA (US); Jian Yu, Warrington, PA (US); Jack Miller, Huntington Valley, PA (US); John Callahan, Broomfield, CO (US)

Correspondence Address: RYAN, MASON & LEWIS, LLP, 1300 POST ROAD, SUITE 205, FAIRFIELD, CT, 06824, US

(73) Assignee: Time Warner Cable Inc, Stamford, CT (US)

(21) Appl. No.: 12/019,766

(22) Filed: Jan. 25, 2008

(51) Int. Cl. H04N 7/173

(52) U.S. Cl. 725/114; 725/131

(57) ABSTRACT

A video content system includes a server module, a video content network coupled to the server module, and a digital set-top terminal coupled to the video content network. The digital set-top terminal in turn includes a processor; an interface coupled to the processor and the video content network; and a memory module. The memory module has at least a partitioned hard disk with a first partition containing digital video programming received over the video content network, and a second partition containing supplemental resources.

### FIELD OF THE INVENTION

The present invention relates generally to communications systems and methods, and, more particularly, to digital set-top terminals for video content networks.

### BACKGROUND OF THE INVENTION

With the advent of digital communications technology, many TV program streams are transmitted in digital formats. For example, Digital Satellite System (DSS), Digital Broadcast Services (DBS), and Advanced Television Standards Committee (ATSC) program streams are digitally formatted pursuant to the well known Moving Pictures Experts Group 2 (MPEG-2) standard. The MPEG-2 standard specifies, among other things, the methodologies for video and audio data compression allowing for multiple programs, with different video and audio feeds, to be multiplexed in a transport stream traversing a single transmission channel. A digital TV receiver may be used to decode an MPEG-2 encoded transport stream, and extract the desired program therefrom.

The compressed video and audio data are typically carried by continuous elementary streams, respectively, which are broken into access units or packets, resulting in packetized elementary streams (PESs). These packets are identified by headers that contain time stamps for synchronizing, and are used to form MPEG-2 transport streams. For digital broadcasting, multiple programs and their associated PESs are multiplexed, into a single transport stream. A transport stream has PES packets further subdivided into short fixed-size data packets, in which multiple programs encoded with different clocks can be carried. A transport stream not only includes a multiplex of audio and video PESs, but also other data such as MPEG-2 program specific information (sometimes referred to as metadata) describing the transport stream. The MPEG-2 metadata may include a program associated table (PAT) that lists every program in the transport stream. Each entry in the PAT points to an individual program map table (PMT) that lists the elementary streams making up each program. Some programs are open, but some programs may be subject to conditional access (encryption), and this information (i.e., whether open or subject to conditional access) is also carried in the MPEG-2 transport stream, typically as metadata.

The aforementioned fixed-size data packets in a transport stream each carry a packet identifier (PID) code. Packets in the same elementary streams all have the same PID, so that a decoder can select the elementary stream(s) it needs and reject the remainder. Packet-continuity counters may be implemented to ensure that every packet that is needed to decode a stream is received.

Video on demand (VOD) systems allow users to select and watch video content over a network. Some VOD systems “stream” content for real-time viewing. Others “download” the content to a set-top box before viewing starts. Use of digital video recorders (DVRs), also known as personal video recorders (PVRs), such as the TiVo® device (registered mark of TiVo Brands LLC, Alviso, Calif.) and the R Replay TV® device (registered mark of Digital Networks North America Inc., Pine Brook, N.J.), is ubiquitous. Such devices may provide some benefits to TV viewers. For example, a prior art DVR allows a user to record his or her favorite TV programs for later review, and to exercise a season-pass-like option wherein every episode of his or her favorite program is recorded for some period. Such devices may automatically record programs for the user based on his or her viewing habits and preferences. The presentation of the recorded programming content can be manipulated by exercising rewind, pause, skip and/or fast-forward functions (hereinafter referred to as “trick mode” or “trick play” functions) furnished by the DVR.

A “network PVR (NPVR)” (also referred to as an NDVR (Network Digital Video Recorder)) service allows the user to perform the analogous DVR functions through use of a network, rather than via a local DVR at the user premises. Unlike a DVR device, the NPVR service allows a user to “reserve” past and future programs for his or her review, even if such reserved programs were not identified by the user before their broadcast. Note that an NDVR can be distinguished from a DVR in that the latter, storage of programs and the like is local to the DVR, while in the former (NDVR) case, such storage is at the server or head end level.

A content-based network, a non-limiting example of which is a cable television network, typically includes “Customer Premises Equipment (CPE),” namely, electronic equipment located within a customer's or user's premises and connected to the network. A non-limiting example of CPE includes set-top terminals (also known as set-top boxes, or, depending on functionality, DVR boxes). Such terminals may have hard drives for recording and storing program content, with capacities of up to several gigabytes.

In some current content-based networks, data besides program content is delivered to set-top terminals. US Patent Publication 2006/0130107 A1 of Gonder et al. is entitled “Method and apparatus for high bandwidth data transmission in content-based networks” and is expressly incorporated herein by reference in its entirety for all purposes. In one embodiment of the Gonder et al. invention, the network comprises a cable network, and the infrastructure comprises that nominally used for on-demand (OD) services such as VOD. The method includes the allocation of dedicated end-to-end network resources via a session request, as well as data flow control and packet size adaptation, by a data server based on feedback from the requesting/receiving client device (e.g., digital cable set-top box or DSTB) within the network. Mechanisms for retransmission requests for error recovery are also provided.

### SUMMARY OF THE INVENTION

Principles of the present invention provide techniques for a digital set-top terminal with a partitioned hard disk. In one aspect, an exemplary method for providing supplemental resources to a digital set-top terminal coupled to a video content network includes the steps of facilitating sending digital video programming from a server module to the terminal over the video content network, and facilitating sending the supplemental resources from the server module to the terminal. The digital video programming is stored in a first partition of a hard disk of the digital set-top terminal, while the supplemental resources are stored in a second partition of the hard disk.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed.

In another aspect, an exemplary video content system includes a server module, a video content network coupled to the server module, and a digital set-top terminal coupled to the video content network. The digital set-top terminal in turn includes a processor; an interface coupled to the processor and the video content network; and a memory module. The memory module has at least a partitioned hard disk with a first partition containing digital video programming received over the video content network, and a second partition containing supplemental resources.

In yet another aspect, an exemplary digital set-top terminal for interconnection with a server module over a video content network includes a processor; an interface coupled to the processor and configured to be coupled to the video content network; and a memory module of the kind just described.

An exemplary embodiment of an apparatus or system, according to still another aspect of the invention, can include a memory and at least one processor coupled to the memory. The processor can be operative to facilitate performance of one or more of the method steps described herein. Non-limiting examples of processors are those in a video server module, a digital set-top terminal, and the like. In a further aspect, an apparatus or system can include means for performing the various method steps. The means can include one or more hardware modules, one or more software modules, or a mixture of one or more software modules and one or more hardware modules.

One or more method steps of the present invention can be implemented in the form of an article of manufacture including a machine readable medium that contains one or more programs which when executed implement such step(s).

Techniques of the present invention can provide substantial beneficial technical effects. For example, one or more embodiments may have one or more of the following advantages:
Provides faster access time for launching application and accessing data resources
Reduce peak loads for bandwidth by downloading application and/or data and/or media files in non-real time during non-peak hours and/or broadcast through a trickle feed at a very low bit rate
Ability to boot up the set-top faster and restore service and/or application quickly on power failure
Fault Tolerance: Ability to run the application and access data information even if the network fails
Provides persistent local storage for storing user and/or service preferences and settings.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 is a functional block diagram illustrating an exemplary hybrid fiber-coaxial (HFC) network configuration useful with one or more embodiments of the present invention;

FIG. 2 is a functional block diagram illustrating one exemplary head-end configuration of the HFC network of FIG. 1;

FIG. 3 presents a system block diagram of an exemplary inventive system including an exemplary inventive digital set-top terminal; and

FIG. 4 is a block diagram of a computer system useful in connection with one or more aspects of the invention.

### DETAILED DESCRIPTION OF PREFERRED EMBODIMENTS

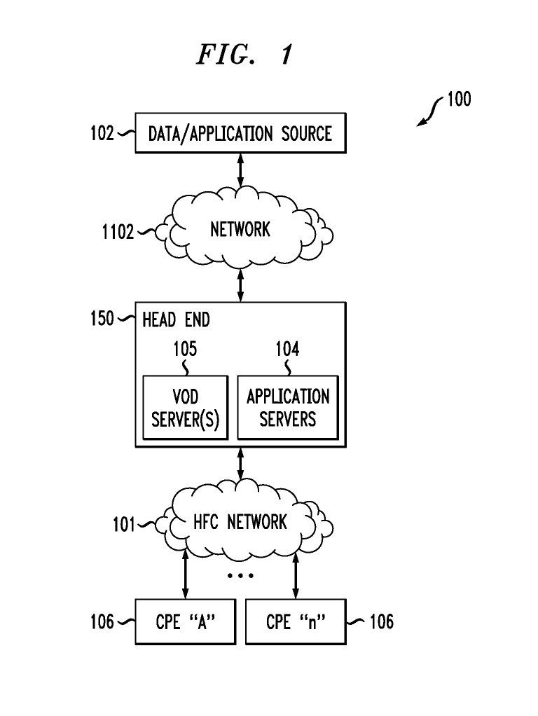

FIG. 1 illustrates a typical content-based network configuration, which is a non-limiting example of a network with which one or more embodiments of the present invention may be used. The various components of the network 100 include (i) one or more data and application origination points 102; (ii) one or more application distribution servers 104; (iii) one or more VOD servers 105, and (iv) customer premises equipment (CPE) 106. The distribution server(s) 104, VOD servers 105 and CPE(s) 106 are connected via a bearer (e.g., hybrid fiber-coaxial or HFC) network 101. Elements 104 and 105 may be located in a head end 150. Material from origination point 102 may be provided to head end 150 via a variety of different types of network, illustrated generally as 1102. A simple architecture comprising one of each of the aforementioned components 102, 104, 105, 106 is shown in FIG. 1 for simplicity, although it will be recognized that comparable architectures with multiple origination points, distribution servers, VOD servers, and/or CPE devices (as well as different network topologies) may be utilized consistent with the invention.

The application origination point 102 comprises any medium that allows an application (such as a data download application or VOD-based application) to be transferred to a distribution server 104. This can include, for example, an application vendor website, compact disk read-only memory (CD-ROM), external network interface, mass storage device (e.g., a redundant array of independent disks (RAID) system), etc. Such transference may be automatic, initiated upon the occurrence of one or more specified events (such as the receipt of a request packet or “ACK” message), performed manually, or accomplished in any number of other modes readily recognized by those of ordinary skill.

The application distribution server 104 comprises a computer system where such applications can enter the network system. Distribution servers are well known in the networking arts, and accordingly not described further herein.

The VOD server 105 is a computer system where on-demand content, as well as data discussed in greater detail below, can be received from one or more data sources 102, and can enter the network system. These sources may generate the content and/or data locally, or alternatively act as a gateway or intermediary from a distant source. The VOD server 105 can include, for example, Session Resource Manager (SRM) functionality, and can “ask” a Digital Network Control System (DNCS) for resources. The DNCS responds with a negative or positive response to the request, and the VOD server implements the appropriate resource allocation logic.

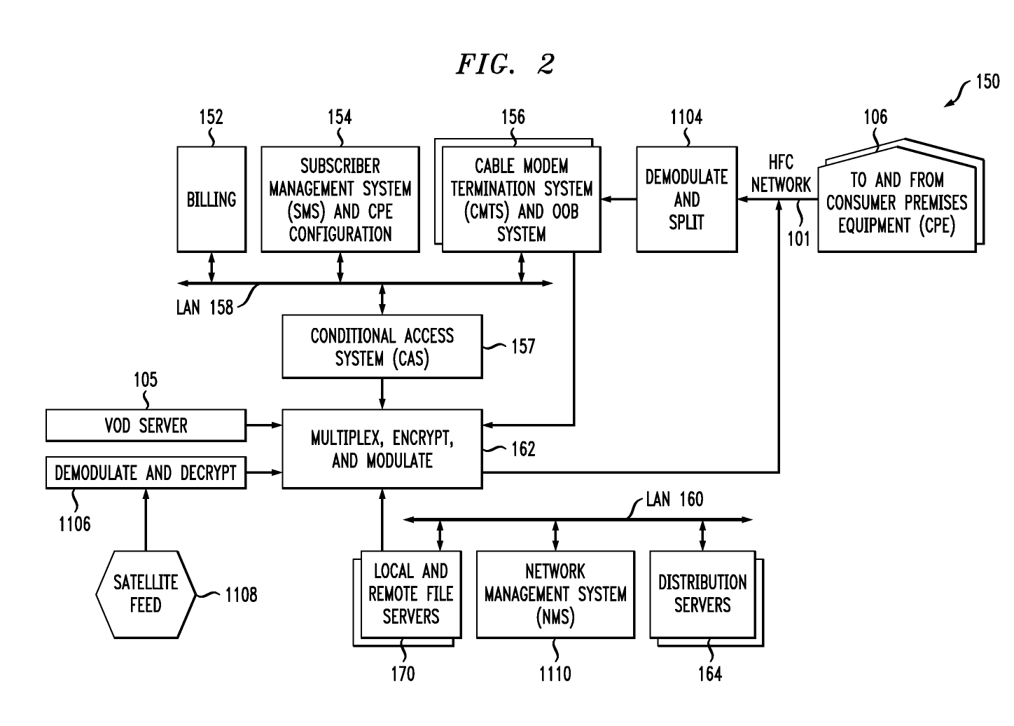

Referring now to FIG. 2, one non-limiting exemplary embodiment of an architecture of head-end 150, useful with one or more embodiments of the present invention, is described. As shown in FIG. 2, the head-end architecture 150 comprises typical head-end components and services including billing module 152, subscriber management system (SMS) and CPE configuration management module 154, cable-modem termination system (CMTS) and out-of-band (OOB) system 156, as well as LAN(s) 158, 160, placing the various components in data communication with one another. It will be appreciated that while a bar or bus LAN topology is illustrated, any number of other arrangements (e.g., ring, star, etc.) may be used consistent with one or more embodiments of the invention. It will also be appreciated that the head-end configuration depicted in FIG. 2 is a high-level, conceptual architecture and that each cable multi-service operator (MSO) may have multiple head-ends deployed using custom architectures.

The exemplary architecture 150 of FIG. 2 further includes a multiplexer/encrypter/modulator (MEM) 162 coupled to the HFC network 101 adapted to “condition” content for transmission over the network. In the present context, the distribution servers 164 are coupled to the LAN 160, which provides access to the MEM 162 and network 101 via one or more file servers 170. The VOD servers 105 are coupled to the LAN 160 as well, although other architectures may be employed (such as for example where the VOD servers are associated with a core switching device such as an 802.3z Gigabit Ethernet device). Since information is carried across multiple channels, the head-end must be adapted to acquire the information for the carried channels from various sources. Typically, the channels being delivered from the head-end 150 to the CPE 106 (“downstream”) are multiplexed together in the head-end and sent to neighborhood hubs (not shown). Application servers 104 are not depicted in FIG. 2, for purposes of illustrative convenience, but such servers may be located, for example, on LAN 158 (in general, on a network such as an IP network in the head end 150 and/or at a regional or national level).

Content (e.g., audio, video, etc.) is provided in each downstream (in-band) channel associated with the relevant service group. As will be discussed in greater detail subsequently herein, in some non-limiting instances, high-speed data is also provided over in-band channels, while associated metadata files are provided either in-band or out-of-band (OOB). To communicate with the head-end, the CPE 106 uses the OOB or DOCSIS® (Data Over Cable Service Interface Specification) channels (registered mark of Cable Television Laboratories, Inc., 400 Centennial Parkway Louisville Colo. 80027, USA) and associated protocols. The OpenCable™ Application Platform (OCAP) 1.0 specification provides for networking protocols both downstream and upstream (Cable Television laboratories Inc.) Upstream communications from CPE 106 may be demodulated and split in block 1104 for communication to block 156.

In some instances, material may also be obtained from a satellite feed 1108; such material is demodulated and decrypted in block 1106 and fed to block 162. Conditional access system 157 may be provided for access control purposes. Network management system 1110 may provide appropriate management functions.

U.S. Patent Application Publication No. 2002/0059619 of Lebar published May 16, 2002 and entitled “Hybrid central/distributed VOD system with tiered content structure” is expressly incorporated herein by reference in its entirety for all purposes. While the Lebar invention teaches techniques for scaling VOD systems, it should be mentioned that in some instances, content distribution download according to one or more non-limiting embodiments of the present invention can use a model similar to Lebar's in a network of local servers.

Many other permutations of the foregoing system components and communication methods may also be used consistent with the present invention, as will be recognized by those of ordinary skill in the field.

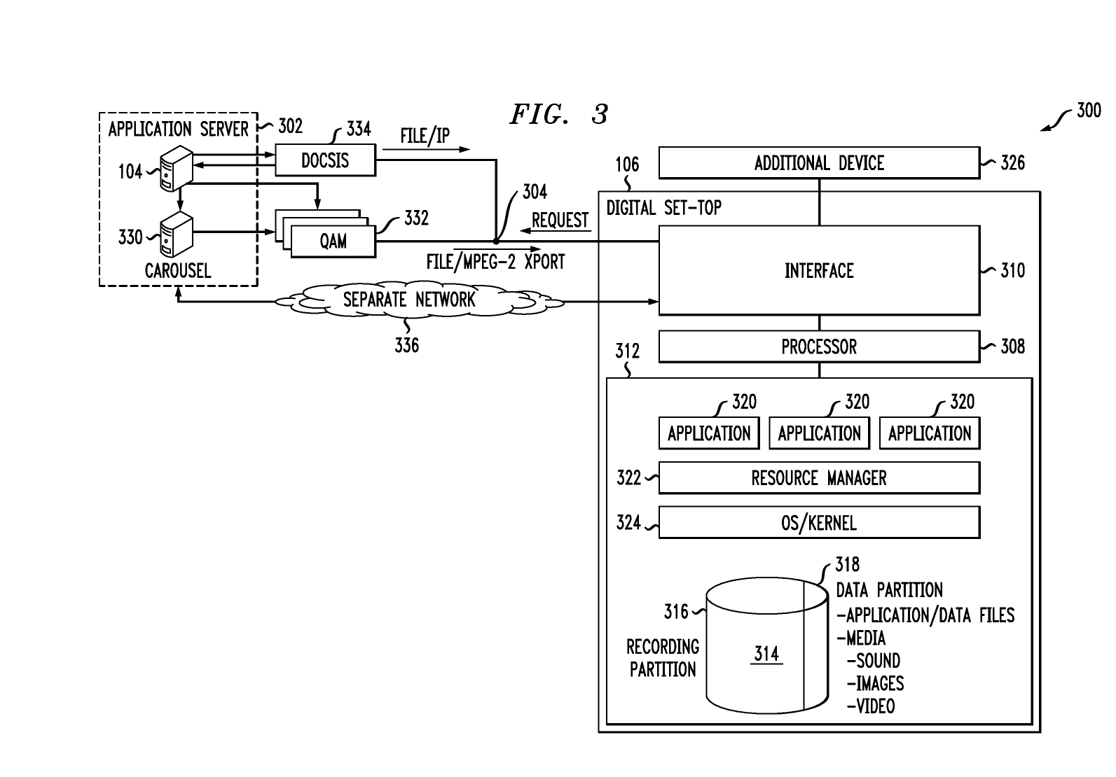

FIG. 3 depicts an exemplary embodiment of a video content system 300, according to an aspect of the invention. System 300 includes server module 302, and a video content network 304 coupled to the server module 302. Also included is a digital set-top terminal 106 coupled to the video content network 304. Terminal 106 is illustrative of what may typically be many such terminals coupled to network 304; only a single terminal is depicted for purposes of illustrative convenience. Network 304 could be, for example, a satellite network, an HFC network 101 as discussed above, and the like.

Terminal 106 can include a processor 308, an interface 310 coupled to the processor 308 and the video content network 304, and a memory module 312. Module 312 may have a number of different components, including at least a partitioned hard disk 314 with a first partition 316 containing digital video programming received over the video content network 304, and a second partition 318 containing supplemental resources.

A number of applications 320, including a conventional “Watch TV” application can be installed in terminal 106 to service those program channels (or programs) afforded a traditional broadcast service. The Watch TV application may reside in memory module 312, and may provide such well known functions as channel navigation control, channel selection in response to a channel change event, etc. A channel change event occurs when a user at set-top terminal 106 issues a command to change from one program channel to another. Such a command is typical of commands that may be issued, say, using a short-range remote control (not shown), which signal is receptive by interface 310 of set-top terminal 106.

Memory module 312 may include, for example, one or more caches, disks, hard drive(s) 314, non-volatile random access memories (NVRAMs), dynamic random access memories (DRAMs), read-only memories (ROMs), and/or Flash ROMs. Some portions (e.g., ROM and some RAM) may be located on processor 308. In a preferred but non-limiting approach, terminal 106 provides DVR functionality, and may be owned and/or provided with data by the cable network operator. In other instances, separate set-top terminals or other memory devices (i.e., a microcomputer with memory, or a removable memory device) are associated with DVRs, which may be owned and/or operated by the cable network operator or someone else. At present, it is believed that combining DVR and STB functionality in a single integrated unit is preferred; however, while preferred, this approach is non-limiting and use of separate DVR and memory devices which communicated via a wired or wireless connection is within the inventive scope.

In some instances of memory module 312, NVRAM may be used for storage of a user's settings and set-top terminal configuration settings, such as parental control codes, favorite channel lineups, set-top terminal setups, channel maps, authorization tables, and forward data channel (FDC) address assignments. DRAM may be used for most application and operating system storage requirements, such as stacks, heaps, graphics, interactive program guide data, marketing data and usage data, and functions such as MPEG-2 or MPEG-4 video decompression, DOLBY DIGITAL® (registered mark of Dolby Laboratories Licensing Corporation, San Francisco, Calif.) Adaptive Transfer Coding 3 (AC-3) audio decoding, and video manipulation. ROM may be used for storage of the operating system 324. Flash ROM may be used for storage of resident application software, as well as patches of the operating system and application software, which software and/or patches are downloaded to set-top terminal 106 from head-end 150 after set-top terminal 106 has been deployed at the user's premises.

Processing unit 308 orchestrates the operations of set-top terminal 106. It executes instructions stored in memory module 312 under the control of the operating system 324. A service application manager (SAM) may form part of such an operating system 324 of terminal 106. The SAM is responsible for, among other things, monitoring channel change events; administering channel, service and other tables in terminal 116; and maintaining a registry of applications in terminal 116. One such application is the aforementioned Watch TV application, which is invoked to service a traditional broadcast channel (or program). Another possible application, mentioned for completeness, is a “NPVR TV” application, which is invoked to service NPVR enabled channels (or programs), and which may be downloaded from head-end 150 to memory module 312. Communication with head end 150 may be through interface 310.

The CPE for VOD often consists of a digital cable set-top box (DSTB) 106 that provides the functions of receiving cable signals by tuning to the appropriate RF channel, processing the received signal and outputting VOD signals for viewing on a display unit. Such a digital set-top box 106 also typically hosts a VOD application (one of applications 320) that enables user interaction for navigation and selection of VOD menu items.

Interface 310 may include an RF front end (including demodulator and decryption unit) for interface with the network 304, as well as a plurality of different types of interfaces (e.g., video/audio interfaces, IEEE-1394 “Firewire”, USB, serial/parallel ports, etc.) for interface with other end-user apparatus such as televisions, personal electronics, computers, WiFi/PAN or other network hubs/routers, etc., depicted generally as “additional device” 326. Other components which may be utilized within the terminal 106 include RF tuner stages, buffer memory (which may be implemented in RAM or otherwise), various processing layers (e.g., DOCSIS MAC or DAVIC OOB channel, MPEG, etc.) as well as media processors and other specialized system-on-chip (SoC) or application=specific integrated circuit (ASIC) devices. These additional components and functionality are well known to those of ordinary skill in the cable and embedded system fields, and accordingly are not described further herein.

The terminal 106 may also be provided with an OCAP-compliant monitor application and Java-based middleware which, inter alia, manages the operation of the terminal and applications 320 running thereon. It will be recognized by those of ordinary skill that myriad different device and software architectures may be used consistent with the invention.

In some instances, the processor 308 and internal bus and memory architecture (not shown) of terminal 106 may be adapted for high-speed data processing to implement high-speed data download functionality, as described in the aforementioned Gonder et al. publication. This may be accomplished, e.g., through a single high-speed multifunction digital processor, an array of smaller (e.g., RISC) cores, dedicated processors (such as a dedicated MPEG media processor, CPU, and interface controller), etc. It will also be appreciated that in other aspects of the invention, because of the inventive storage on partition 318, high-speed data download functionality may not be needed.

As noted, memory module 312 can include a number of applications 320, and an operating system (kernel) 324. A resource manager 322 may also be provided. As also noted, interface 310 may include, in some instances, an interface to at least one additional device 326. The aforementioned supplemental resources may be, for example, modules and/or drivers configured to be dynamically linked and loaded within the operating system 324 for accessing the additional device(s) 326.

Each terminal 106 may have, as part of interface 310, a physical interface for connecting to the (video) distribution network 304, e.g., a coaxial connection. Microprocessor 308 may be programmable and may execute program code that a user loads via interface 310. Interface 310, in addition to the coaxial connection and interface to additional device(s) 326, may also include an infrared interface for receiving signals from a remote control, a smartcard reader for reading and writing to smartcard media, etc. Interface 310 may also include interface functionality to connect with a separate network 336 (discussed further below). The terminal 106 may also maintain a codec for decoding audio and video data that it receives via the distribution network 304. As is well known to those of skill in the art, the terminal 106 may implement the codec in hardware or as stored software.

In some instances, server module 302 includes an application server 104 and a carousel 330 coupled to the application server 104. Further details are provided elsewhere. The functionality associated with module 302 may be located, for example, in head end 150.

The supplemental resources can be received, for example, over the video content network 304, in-band with the digital video programming, as indicated by the notation “File/MPEG-2 Xport” and the quadrature amplitude modulation (QAM) channels indicated at 332. In another possible configuration, the supplemental resources are received over the video content network 304, out-of-band, for example, over a DOCSIS® network, as indicated at 334. In yet another possible configuration, a separate network 336 is included for transmission of the supplemental resources. The separate network 336 is interposed between the server module 302 and the terminal 106, and in such case, the supplemental resources are received over the separate network.

Dedicated data partition 318 on the terminal's hard drive 314 is separate from the primary recording partition 316. The terminals 106 are equipped with several hundred gigabyte hard drives 106 with the primary use of recording digital video programming, either live or as scheduled programming. However, according to one or more inventive techniques, part of the total storage can be configured as a separate partition 318 that can be used to download and cache various data resources and/or files.

One example of a supplemental resource is an application file, for example, a native application that can directly execute as machine code on the set-top CPU, or an application that is interpreted and/or executed on middleware and/or a virtual machine running on the set-top 106. Java, Flash, and Enhanced TV Binary Interchange Format (EBIF) applications are non-limiting examples of interpreted applications.

OS Modules and drivers are another example of supplemental resources. These may include, for example, various types of modules and/or drivers that can be dynamically linked and loaded within the operating system 324 on the terminal 106 to access and exercise additional devices connected to the terminal, such as device 326.

Data resource and/or files are yet another example of supplemental resources, and may constitute data resources that are consumed by various interactive television (ITV) applications enabled on the set-top terminal 106. The data can be, for example, in ASCII or binary form and may be packed in a format that can be parsed by various interactive set-top applications. Examples of such applications include meta-data related to broadcast and on-demand programs available as offerings to the viewer; a database that supports search of programming based on various attributes; meta-data related to various ITV applications that allow users to access weather, news, sports, stocks information, and the like, and/or user settings and/or preferences for various applications stored persistently.

Still another example of supplemental resources are media files that are processed by various applications, for example, audio files that can be used as audio effects in an application; video rich background in an application (“video rich background” encompasses, for example, video images, still images, background art videos, images related to movies-on-demand that are cached for faster access, poster art images for titles in a VOD catalog, and/or images that can be used in various screens in applications); and/or audio and/or video programs that are part of the ITV (or other) application. By way of example, in some instances, a portal application may be used to navigate to different applications or content in a system and the video rich background can be employed in conjunction with the portal.

It should be noted that, in one or more embodiments, terminal 106 can run applications from networks 304 and/or 336 using data on partition 318; applications from partition 318 using data from networks 304 and/or 336; and/or applications and data both from partition 318.

As previously noted, there are a number of ways in which the supplemental resources can be downloaded to the partition 318 on drive 314 of set-top 106; at a high level, these include via separate network 336, in-band over network 304, or out-of-band over network 304. The following are some non-limiting specific examples:
1. IP Connection: The set-top 106 can use a point-to-point or a multicast session over an IP connection on a DOCSIS (Cable Modem) or Out-Of-Band network for downloading and caching resources.
   The set-top can use a file transfer protocol (FTP) or (HTTP) client that runs a transfer control protocol (TCP) session on an Internet protocol (IP) connection to download the resources. Multi-cast sessions are done through user datagram protocol (UDP) using a broadcast/multicast address.
   A DOCSIS channel provides more bandwidth than the legacy Out-Of-Band channel on some cable television networks, and allows download of larger resources, and a greater number of number of resources, at a higher bit-rate.
   In point-to-point mode, the set-top 106 can directly connect with an application server 104 on the IP network that hosts the required resources.
2. In-band MPEG transport: The set-top 106 can also use the MPEG-2 transport data stream that is QAM modulated on various frequencies (see 332) to download resources, also referred as in-band download. This in-band download can work, for example, as a:
   Broadcast-Carousel mode, employing carousel 330, where each terminal 106 can tune to a particular frequency on the spectrum and listen for a broadcast data stream for new resources that are available for download and can be cached in partition 318, or
   an On-demand/point-to-point mode where the terminal 106 requests a specific resource and the server 104 plus network 304 stream the required resource(s) through an in-band channel.

In one or more embodiments, the separate data partition 318 on DVR hard drive 314 can be configured as a regular block-based file system, similar to the implementation on most desktop computers. This file system can be accessed, managed, and configured through standard File input/output (I/O) application program interfaces (APIs) as defined in ANSI standard system APIs and widely adopted by various operating systems.

The size of data partition 318 can be configurable, and can be initialized to a default value before the terminal 106 is deployed in the field. The file system also provides a hierarchical directory structure and allows applications to organize and/or group files into folders. Access to the file system can be controlled using a security model that provides tiered multi-level access and configurations for the OS 324 and various applications 320 running on the terminal 106.

Since the space available on the data partition 318 is a always of finite size, the set-top 106 preferably includes a resource/file manager 322 that implements algorithms for caching and cleanup of files based on certain business and/or application rules. If there are no such rules defined by the operator or by the application, then by default, the resource manager can implement, for example:
Least Recently Used (LRU) Algorithms to replace files in case the partition 318 is running low in free space. LRU algorithms can be applied globally across resources for all applications rather than in a specific application context.
Working Set: Algorithms that are based on recent and future references to the resources by the application(s). These algorithms are applied in a particular application context rather than globally, and can be more effective in some instances.

If the application or the operator explicitly specifies a set of rules for resource management, then these rules could either work in conjunction with the default algorithms run by the resource manager, or can completely over-ride the defaults.

In some instances, the future need for various resources can be estimated based on the current usage rates, as collected from some or all of the subscribers in the network. In the event an application 320 requests a resource that is not available on the terminal 106, then it can initiate a download or streaming of the desired resource, which can replace a resource that is less likely to be used or is invalid. For the broadcast and carousel of resources, a scheduling server can use heuristics based on subscriber usage data to decide on a set of resources that can be spooled using the bandwidth configured for this service.

Various types of ITV applications may use the data partition 318 as local storage on the DVR terminals 106. Service navigator applications may include, for example, interactive program guide (IPG) or VOD applications. Current IPGs are restricted by the amount of meta-data that can be downloaded in memory on the terminal 106. With the use of additional hard drive storage, various additional meta-data related to programming, users' and/or critics' reviews, search, program images, and the like can be downloaded and cached on the partition 318, and can thus be made readily available.

Once the data is downloaded and cached on the hard drive partition 318 and is validated, the overhead of downloading data every time the set-top reboots or loses power is avoided. This also speeds up the process of invoking and/or switching of various ITV applications on the set-top 106.

With regard to VOD, as the number of titles that are offered through on-demand keeps increasing, it becomes harder to download meta-data for all the available titles within the limited run-time memory available on the terminal 106. Hence, the local data partition 318 can be used to download once and store meta-data for the large number of titles that are available as VOD programs. The local storage 318 can also be used to download and store poster art images for many of the VOD titles, which can be used to make the VOD application user interface (UI) more interesting, user friendly and intriguing.

Various types of ITV applications may include, for example, games, advertisements, a portal user interface (UI), and the like. Various types of arcade games that can run on the limited resource set-tops 106 can be made available to the subscriber. This will provide an advantage over past systems, which have been hampered by issues with long download times and the limited bandwidth that is available on the carousel 330 to make available sufficient games intriguing to the user. By providing local storage partition 318 on the terminal 106, a good set of games for the games package can be downloaded, for example, at a trickle feed in non-real time (during non-peak times) and can be made available to the subscriber for quick access without long loading times.

With regard to advertisements, note that, as used herein, a video-on-demand advertisement can occur, for example, during a “pause” command or between video segments of a feature.

With regard to advertisements, it may be advantageous to enable more interactive advertisements that can be targeted to a terminal 106 (or a subscriber associated therewith) in the form of a video program and/or as an interactive overlay. In one or more embodiments, there may be a conventional video part, with graphic overlays stored in inventive partition 318 on the hard drive 314. The local hard drive storage 318 on the terminal 106 provides the ability to download and cache various types of media content that can be used for advertisement during a number of scenarios:
Ad spots in broadcast programming replacing network ads with targeted ads
In VOD programming, when in pause mode and/or in between different content segments
As screen savers
As interactive overlays.

Operators may build a local portal or main menu that is customized to their region, division, and/or offerings. This portal can use rich media content for implementing a high-end UI for, e.g., video backgrounds, audio sounds, and/or JPEG/PNG graphics. Since the main menu is a frequently accessed application, it helps to download it once and store the application with all its rich media content on the local storage 318 on the terminal 106.

In the past, many interactive TV applications have been deployed to allow subscribers to access information and/or data that is generally available on web portals but now can be conveniently accessed through TV sets; however, this process has been limited by the limited real-time bandwidth available on the network and by the high latency to access these applications and/or data. By providing local storage 318 on the terminal 106, these applications can be downloaded once and can be cached on the partition 318, thus providing fast access time (as compared to the time taken to download every time from a carousel 330).

The data corresponding to these applications can also be downloaded in a non-real time manner over a slow trickle feed on, for example, a cable card portion of interface 310, thus building up the cache on the terminal 106 in few hours. The user can also create his or her own settings and/or preferences, and thus filter the data such that it is only within his or her selection. These data feeds can be configured from, for example, various sources on the internet, including news, sports, stocks, horoscopes, reviews, and the like.

The local storage 318 can also be used to persistently store subscriber preferences and/or settings for many different applications, for example, a personalized channel-lineup, program reminders, bookmarking of On-Demand programs, layout and styles, and the like.

By way of review, terminals 106 have hard drives 314 available with several gigabytes of storage. A space 318 is carved out on the hard drive 314 to store (cache) applications and/or other data resources that can be used by ITV applications and the like. Currently, hard drives are only used to store (video) content such as MPEG. According to one or more embodiments of the invention, data that the STB 106 can use on startup is stored in partition 318. In one or more embodiments of the invention, graphics, asset metadata for movies, on demand applications, games, program guide data, and the like can be downloaded to partition 318. In some instances, supplemental material can be downloaded in a trickle fashion, while in other instances, high-speed download can be employed, as in the aforementioned US Patent Publication 2006/0130107. In any event, data or other supplemental material can be cached in partition 318 on box 106 and made available for various applications. The applications may also be downloaded to partition 318, or may be pre-loaded thereon.

Non-limiting examples of supplemental material that can be stored in partition 318 include games (e.g., periodically download the “top 10” games to terminal 106); metadata; tailored advertisements; movies (or other video) on demand: jacket art, metadata; news, weather, and/or sports ticker applications which may periodically download data, cache it onto the partition 318, and make it available to the user; user interfaces (portals with higher-end graphics content); content protection schemes; audio content; graphics content; indeed, any application or data resource. It should be noted that, with regard to the aforementioned “audio content,” such content can be in different formats and different encodings, such as WAV, MP3, and the like. These audio files can be used in applications for enhancing audio effects, for background music, animation, to provide user feedback for “click-throughs,” navigation purposes, and the like. The audio files should be distinguished from conventional streamed audio content.

Thus, one or more embodiments provide a system including a DVR component 106 with stored applications and the ability to extract those applications and use them to do things in addition to processing video. The hard drive partition 318 on DVR box 106 is used to download data and/or applications, cache same, and make same available to the viewer.

An electronic program guide (EPG) is a database with program guide information, typically available 7-14 days in advance of a broadcast date. With one or more embodiments of the invention, carousel 330 can be employed to spool the guide data through and cache it onto the partition 318 and there is no need to initiate a request for the EPG data at every instance. Advantageously, this guide data can be downloaded to the partition 318 during hours where the DVR 106 is not typically in use. This will alleviate delays in STB operation during active hours due to latency from network downloads.

As noted, network 304, with which one or more embodiments of the invention can be employed, may be an HFC network 101. Network 304 may be a VOD network or a conventional broadcast type CATV system to access content. In some instances, network 304 may be a digital broadcast satellite (DBS) network. Unlike an HFC cable network, DBS networks are typically one-way broadcast only systems unless there is a phone link present. In some instances, using the present invention, a “virtual upstream” aspect can be implemented, wherein an embodiment of system 300 using a DBS network as network 304 mimics upstream communication. For example, to simulate upstream ordering of video games on demand, such games would already be stored on partition 318 in the hard drive 314, but the user would perceive access to the games as an interactive feature, even though they were already stored on the terminal. There is no return path in DBS, but in this “virtual upstream” approach, the user would think he or she was communicating interactively with whatever features were stored on the hard drive partition 318. In this approach, when the user “asks” for something, the terminal 106 is not really getting anything, just activating something that has already been stored. Such activation could involve, for example, a telephone return path or updating of billing data in block 152. The “virtual upstream” aspect may be particularly useful in any case where there is no broadband back channel. Cable systems typically provide a return path and materials can be pulled off the network in response to upstream requests, such that the “virtual upstream” aspect may be of less utility in cable systems.

Non-limiting examples will no be provided regarding how various types of supplemental material may be stored on partition 318. With regard to games, for example, an MSO may decide to “push” the top 10 games down to the subscriber terminals 106. The MSO initiates the process and caches the games onto the partitions 318 of subscriber terminals 106. In an alternative approach, the subscriber asks for a game he or she is interested in and initiates the transfer to cache it onto the partition 318 (a “pull” approach). For pushing, the MSO can use some heuristics to see what the usage of various games or other applications or data is and to develop a push model. Pulling will be responsive to a subscriber request. It should be noted that the aforementioned “pushing” and “pulling” are not limited to games, but may be applied to any materials to be downloaded.

With regard to “Movies on Demand,” one or more embodiments may employ the partition 318 to store a UI component, jacket art, metadata and so on (conventional storage of video per se can be done on partition 316); “Movies on Demand” will themselves be stored on the head end 150.

In another aspect, one or more instances of the invention may provide a “quarantine” function, wherein only the applications 320 will have (restricted) access to the partition 318; in these instances, there is no way for the subscriber/user to directly access the partition 318.

One or more of the following types of network are exemplary of those that can be used with one or more embodiments of the invention:

a cable television network (or other content network, for example, a telecommunications company video delivery network such as fiber to the home (FTTH), fiber to the curb (FTTC), or digital subscriber line (DSL))(e.g., for network 304),

a wireless network such as a cellular network (e.g., for network 336),

a Transmission Control Protocol/Internet Protocol (TCP/IP) network (e.g., for network 336),

a DOCSIS® (Data Over Cable Service Interface Specification) network (registered mark of Cable Television Laboratories, Inc., 400 Centennial Parkway Louisville Colo. 80027, USA) (e.g., an out-of-band part of network 304, as shown at 334).

Another aspect of the invention includes a digital set-top terminal 106 for interconnection with a server module 302 over a video content network 304. The terminal 106 includes a processor 308, an interface 310 coupled to the processor 308 and configured to be coupled to the video content network 304; and a memory module 312 having at least a partitioned hard disk 314 with a first partition 316 configured to contain digital video programming received over the video content network 304, and a second partition 318 configured to contain supplemental resources.

Yet another aspect of the invention includes a method for providing supplemental resources to a digital set-top terminal 106 coupled to a video content network 304. The method includes the step of facilitating sending digital video programming from a server module 302 to the terminal 106 over the video content network 304. The digital video programming is stored in first partition 316 of hard disk 314 of the digital set-top terminal 106. The method also includes facilitating sending the supplemental resources from the server module 302 to the terminal 106, with the supplemental resources being stored in second partition 318 of hard disk 314.

### Exemplary Requirements for Hard Drive Partition

The following is a non-limiting example of requirements for partitioning a DVR set-top hard drive in one particular application of the invention. Other instances of the invention may differ. “DVR” refers to a digital video recorder and “HD” refers to a hard drive. The terms “MUST,” “SHALL,” or “REQUIRED” mean that the item is an absolute requirement of the exemplary specification. The terms “MUST NOT” or “SHALL NOT” mean that the item is an absolute prohibition in this specification. The terms “SHOULD” or “RECOMMENDED” mean that there may exist valid reasons in particular circumstances to ignore this item, but the full implications should be understood and the case carefully weighed before choosing a different course. The term “SHOULD NOT” means that there may exist valid reasons in particular circumstances when the listed behavior is acceptable, or even useful, but the full implications should be understood and the case carefully weighed before implementing any behavior described with this label. The terms “MAY” or “OPTIONAL” mean that the given item is truly optional. It is to be emphasized that items having a particular requirement in this example may have a different requirement in another instance of the invention; for example, something labeled a “must” here might be “optional” in another instance, or vice versa.

In this particular example, requirements for the support of an application partition are classified in four categories:

General
Requirements related to features and functions of the application partition and the file system supported

Performance
Performance requirements for the application partition

Access and Management APIs
Requirements for support of various APIs that are necessary to access and manage the partition and the files on this partition

Security and Access Control
Requirements for access control of files and APIs.

In this particular example, the general requirements are as follows:
R1: Application partition must provide support to store application and data modules as files of varying sizes.
R2: The OS must support an efficient file system (equivalent to a FAT32) on this partition.
R3: File system on this partition must be robust and ensure high reliability and integrity of the data store on the hard drive.
R4: File system on this partition must be able to support long filenames with at least the maximum length equal to 64.
R5: All ASCII characters, including spaces, must be allowed in a file name except “*/:?< >\”
R6: Forward slash character (/) in a file path name must be used as a delimiter between directory names and filenames.
R7: Size of this partition must be configurable through the operator management console located in the cable head-end.
R8: The size of the partition can be configured from minimum IGB to up to 10% of the total capacity of the HD on the DVR set-lop.
R9: It is not required for this application partition to source or sink A/V media files from the MPEG/tuner device on the set-top.

In this particular example, the performance requirements are as follows:
R10: Access to the application partition does not have any stringent real time constraints; however the data access must not incur large latency that is unacceptable for set-top applications.
R11: The set-top architecture and OS must properly arbiter the memory bus-disk access bandwidth such that the access to the application partition does not adversely affect the DVR functionality of the set-top.

In this particular example, the following APIs are required to be supported by the OS for configuring, accessing and managing the application partition as well as the data files stored on this partition.
R1: The OS must have APIs to perform following functions for the application partition:
   Mount—Mounts the partition to a logical node passed as an argument.
   UnMount—Unmounts the partition.
   Format—Formats the file system on the partition
   ConsistencyCheck—performs a consistency check and reports any problems with the device and file system
   Status—Reports total size, free size, bad sectors/clusters, and fragmentation.
   DeFragment—Re-allocates sectors on the partition to coalesce small free fragments to create larger clusters.
R3: Following directory management APIs must be supported for the Application Partition:
   CreateDiectory—Creates a new directory as per the path and name specified.
   RemoveDirectory—Removes an empty directory as per the path and name specified.
   RenameDirectory—Renames an existing directory to a new name specified if there are no files open from that directory.
   List—APIs to navigate through all the sub directories and files within a given directory.
   Search—APIs to search files/directories whose names match a certain string pattern within a give directory.
R2: Following file access APIs must be supported for the Application Partition:
   Create—Creates a new file
   CreateLink—Creates a link file with the name passed to create a reference to an existing file or directory.
   Delete—Deletes a file and free up the space.
   Rename—Renames a files that is not currently opened by an application
   Open—Opens a file and returns a reference handle or descriptor that can be used by other file operation APIs such as read, write, append, close. A file can be opened either as read only, write only and read-write modes.
   Close—Closes a file and release the reference.
   Stat—Provides access to attributes related to the current status of the file
   Seek—Allows setting the current position in a file.
   Read—API to read the specified number of bytes from the current location in file to a memory buffer passed by the application.
   Write—API to write the specified number of bytes starting from the current location in file from a memory buffer passed by the application
   Append—API to write the specified number of bytes at the end of the file from a memory buffer passed by the application

The following are exemplary security and access control rules:
R12: At a time the OS must restrict only one application to open a file in a write mode.
R13: At a lime the OS must allow multiple applications to open a file in read mode.
R14: All the partition management APIs must only be accessible to the default application. All other applications must not be able to call these partition management APIs.

### System and Article of Manufacture Details

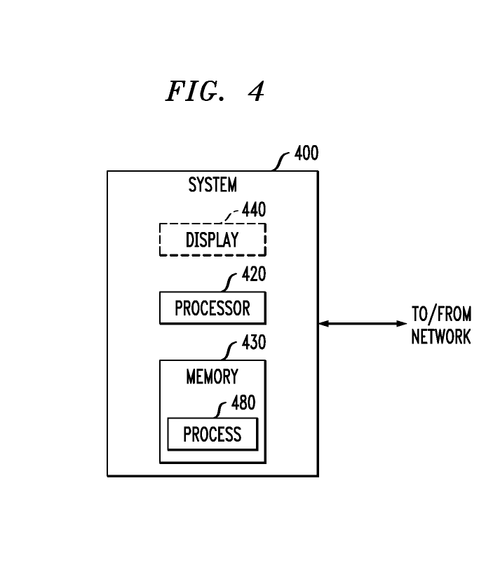

The invention can employ hardware and/or software aspects. Software includes but is not limited to firmware, resident software, microcode, etc. An exemplary embodiment of an inventive apparatus can include a memory and at least one processor coupled to the memory. The processor can be operative to facilitate performance of one or more of the method steps described herein. In another aspect, the apparatus can include means for performing the various method steps. The means can include one or more hardware modules, one or more software modules, or a mixture of one or more software modules and one or more hardware modules (appropriate interconnections via bus, network, and the like can also be included). One or more method steps of the present invention can be implemented in the form of an article of manufacture including a machine readable medium that contains one or more programs that when executed implement such step or steps. FIG. 4 is a block diagram of a system 400 that can implement part or all of one or more aspects or processes of the present invention, processor 420 of which is representative of processors (such as those in elements or blocks 102, 104, 105, 106, 150, 330, 308, 326) depicted in the other figures. In one or more embodiments, inventive steps are carried out by one or more of the processors in conjunction with one or more interconnecting network(s). As shown in FIG. 4, memory 430 configures the processor 420 to implement one or more aspects of the methods, steps, and functions disclosed herein (collectively, shown as process 480 in FIG. 4). The memory 430 could be distributed or local and the processor 420 could be distributed or singular. The memory 430 could be implemented as an electrical, magnetic or optical memory, or any combination of these or other types of storage devices. It should be noted that if distributed processors are employed, each distributed processor that makes up processor 420 generally contains its own addressable memory space. It should also be noted that some or all of computer system 400 can be incorporated into an application-specific or general-use integrated circuit. For example, one or more method steps could be implemented in hardware in an ASIC rather than using firmware. Display 440 is representative of a variety of possible input/output devices.

As is known in the art, part or all of one or more aspects of the methods and apparatus discussed herein may be distributed as an article of manufacture that itself includes a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, EEPROMs, or memory cards) or may be a transmission medium (e.g., a network including fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. Such methods, steps, and functions can be carried out, e.g., by processing capability on individual elements in the other figures, or by any combination thereof. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Thus, elements of one or more embodiments of the present invention can make use of computer technology with appropriate instructions to implement method steps described herein.

Accordingly, it will be appreciated that one or more embodiments of the present invention can include a computer program including computer program code means adapted to perform one or all of the steps of any methods or claims set forth herein when such program is run on a computer, and that such program may be embodied on a computer readable medium. Further, one or more embodiments of the present invention can include a computer including code adapted to cause the computer to carry out one or more steps of methods or claims set forth herein, together with one or more apparatus elements or features as depicted and described herein.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A video content system comprising:
a server module;
a video content network coupled to said server module; and
a digital set-top terminal coupled to said video content network, said digital set-top terminal in turn comprising:
a processor;
an interface coupled to said processor and said video content network; and
a memory module having at least a first partition containing digital video programming received over said video content network, and a second partition containing supplemental resources.

2. The system of claim 1, wherein said supplemental resources comprise at least data.

3. The system of claim 1, wherein said supplemental resources comprise at least applications.

4. The system of claim 3, wherein said applications comprise at least native applications capable of executing as machine code on said terminal.

5. The system of claim 3, further comprising a virtual machine layer on said terminal, wherein said applications are configured to be at least one of executed and interpreted by said virtual machine layer.

6. The system of claim 1, further comprising an operating system on said terminal, wherein:
said interface further comprises an interface to at least one additional device; and
said supplemental resources comprise at least one of modules and drivers configured to be dynamically linked and loaded within said operating system for accessing the at least one additional device.

7. The system of claim 1, further comprising at least one interactive television application enabled on said terminal, wherein said supplemental resources comprise data resources for consumption by said at least one interactive television application.

8. The system of claim 7, wherein said data resources comprise at least one of:
meta-data for broadcast programs of said video content network;
meta-data for video-on-demand programs of said video content network;
a program search database;
meta-data for said at least one interactive television application; and
user settings for at least one application persistently stored in said memory.

9. The system of claim 7, wherein said interactive television application comprises at least one of:
an electronic program guide, in which case said supplemental resources comprise at least meta-data of said electronic program guide;
a ticker, in which case said supplemental resources comprise at least data for said ticker;
a game,
an advertisement, and
a main menu of a cable multi-service operator, said menu comprising a menu application with associated rich media content.

10. The system of claim 9, wherein said interactive television application comprises at least said advertisement and wherein said advertisement comprises at least one of a targeted advertisement, a video-on-demand advertisement, a screen saver advertisement, and an interactive overlay advertisement

11. The system of claim 1, wherein said supplemental resources are trickle-fed from said server module to said second partition in non-real-time.

12. The system of claim 1, wherein said memory stores at least one application and wherein said supplemental resources comprise media files configured for processing by said at least one application.

13. The system of claim 12, wherein said media files comprise at least one of:
audio files configured for use as audio effects in said application;
a video rich background for said application; and
at least one of an audio program and a video program configured as part of said application.

14. The system of claim 1, wherein said server module comprises an application server and a carousel coupled to said application server.

15. The system of claim 1, wherein said supplemental resources are received over said video content network, in-band with said digital video programming.

16. The system of claim 1, wherein said supplemental resources are received over said video content network, out-of-band.

17. The system of claim 1, further comprising a separate network for transmission of said supplemental resources, said separate network being interposed between said server module and said terminal, wherein said supplemental resources are received over said separate network.

18. The system of claim 1, wherein said supplemental resources are quarantined from a user of said set-top terminal.

19. The system of claim 1, wherein said supplemental resources are received, at least in part, based on initiation by a cable multi-service operator who operates said video content network.

20. The system of claim 1, wherein said supplemental resources are received, at least in part, based on initiation by a user of said set-top terminal.

21. The system of claim 1, wherein said supplemental resources comprise a content-protection module.

22. The system of claim 1, wherein said video content network comprises a digital broadcast satellite network and wherein said supplemental resources are configured to create a virtual upstream environment for a user of said set-top terminal.

23. A method for providing supplemental resources to a digital set-top terminal coupled to a video content network, said method comprising the steps of:
sending digital video programming from a server module to said terminal over said video content network,
storing said digital video programming in a first partition of a hard disk of said digital set-top terminal;
sending said supplemental resources from said server module to said terminal, and
storing said supplemental resources in a second partition of said hard disk.

24. The method of claim 23, wherein said supplemental resources comprise at least data.

25. The method of claim 23, wherein said supplemental resources comprise at least applications.

26. The method of claim 25, wherein said applications comprise at least native applications capable of executing as machine code on said terminal.

27. The method of claim 25, wherein a virtual machine layer is present on said terminal, and wherein said applications are configured to be at least one of executed and interpreted by said virtual machine layer.

28. The method of claim 23, wherein an operating system is present on said terminal, and wherein said supplemental resources comprise at least one of modules and drivers configured to be dynamically linked and loaded within said operating system for accessing at least one additional device coupled to said terminal.

29. The method of claim 23, wherein at least one interactive television application is enabled on said terminal, and wherein said supplemental resources comprise data resources for consumption by said at least one interactive television application.

30. The method of claim 29, wherein said data resources comprise at least one of:
meta-data for broadcast programs of said video content network;
meta-data for video-on-demand programs of said video content network;
a program search database;
meta-data for said at least one interactive television application; and
user settings for at least one application persistently stored in a memory of said terminal.

31. The method of claim 29, wherein said interactive television application comprises at least one of:
an electronic program guide, in which case said supplemental resources comprise at least meta-data of said electronic program guide;
a ticker, in which case said supplemental resources comprise at least data for said ticker;
a game,
an advertisement, and
a main menu of a cable multi-service operator, said menu comprising a menu application with associated rich media content.

32. The method of claim 31, wherein said interactive television application comprises at least said advertisement and wherein said advertisement comprises at least one of a targeted advertisement, a video-on-demand advertisement, a screen saver advertisement, and an interactive overlay advertisement

33. The method of claim 23, wherein said step of facilitating sending said supplemental resources to said terminal comprises facilitating trickle-feeding said supplemental resources from said server module to said second partition in non-real-time.

34. The method of claim 23, wherein said terminal has a memory storing at least one application and wherein said supplemental resources comprise media files configured for processing by said at least one application.

35. The method of claim 35, wherein said media files comprise at least one of:
audio files configured for use as audio effects in said application;
a video rich background for said application; and
at least one of an audio program and a video program configured as part of said application.

36. The method of claim 23, wherein, in said step of facilitating sending said supplemental resources, said supplemental resources are sent over at least one of:
said video content network, in-band with said digital video programming;
said video content network, out-of-band; and
a separate network.

37. The method of claim 23, wherein said step of facilitating sending said supplemental resources, is carried out, at least in part, based on initiation by a cable multi-service operator who operates said video content network.

38. The method of claim 23, wherein said step of facilitating sending said supplemental resources, is carried out, at least in part, based on initiation by a user of said set-top terminal.

39. The method of claim 23, wherein said supplemental resources comprise a content-protection module.

40. The method of claim 23, wherein said video content network comprises a digital broadcast satellite network and wherein said supplemental resources are configured to create a virtual upstream environment for a user of said set-top terminal.

41. A digital set-top terminal for interconnection with a server module over a video content network, said terminal comprising:
a processor;
an interface coupled to said processor and configured to be coupled to the video content network; and
a memory module having at least a first partition configured to contain digital video programming received over the video content network, and a second partition configured to contain supplemental resources.

42. A system for providing supplemental resources to a digital set-top terminal coupled to a video content network, said system comprising:
means for sending digital video programming from a server module to said terminal over said video content network,
means for storing said digital video programming in a first partition of said digital set-top terminal;
means for sending said supplemental resources from said server module to said terminal, and
means for storing said supplemental resources in a second partition of said digital set-top terminal.
